(19) United States
(12) Patent Application Publication
(10) Pub. No.: US 2008/0279537 A1
(43) Pub. Date: Nov. 13, 2008

(54) Information Recording/Reproducing Apparatus

(76) Inventors: Yosuke DOBA, Fujisawa (JP); Hiroaki Tachibana, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/055,406

(22) Filed: Mar. 26, 2008

(30) Foreign Application Priority Data
Mar. 29, 2007 (JP) 2007-088350

(51) Int. Cl. H04N 5/917

(52) U.S. Cl. 386/124; 386/E05.007

(57) ABSTRACT

The present invention provides a hybrid video camera that can be downsized while restraining heat generation during operation. The hybrid video camera comprises: a camera block which shoots a subject and generates image data; a hard disk drive which records and reproduces the image data in relation to the hard disk; an optical disc drive which records and reproduces the image data in relation to an optical disc; and a control module which controls operations of these modules. The control module instructs only the hard disk drive to record shot image data from the camera block in the shooting mode, and selects the sleep mode in which the camera block stands ready with the minimum power consumption in the reproduction or editing mode using the optical disc drive.

### CLAIM OF PRIORITY

The present application claims priority from Japanese application Ser. No. JP 2007-088350, filed on Mar. 29, 2007, the content of which is hereby incorporated by reference into this application.

### BACKGROUND OF THE INVENTION

The present invention relates to an information recording/reproducing apparatus. An example shown herein is a hybrid video camera which shoots a subject and records shot image data on at least two different types of recording media.

In recent years, a DVD camera equipped with an optical disc (DVD) and an HDD camera equipped with a hard disk as a recording medium are commercially produced, attracting increasing attention. Since the DVD camera uses a removable DVD medium, it has an advantage that the recorded image data can be stored as a disc as it is. The HDD camera is provided with a mass-storage medium allowing long-time recording. Further, a camera equipped with both media, DVD and HDD, to take advantages of both (hereafter referred to as DVD/HDD hybrid camera) has been announced.

The DVD/HDD hybrid camera operates on the premise that shot image data can be recorded on a desired medium, DVD or HDD (or both). However, since the hybrid camera operates on a battery, the reduction of power consumption has been a problem. As a measure for this problem, JP-A-2004-349810 discloses a digital camera equipped with at least two different types of external recording media having different power consumption. When recording a moving image with the digital camera, the moving image is once recorded on an external recording medium having lower power consumption and, after the data recorded on the external recording medium reaches a predetermined capacity, the moving image is recorded on an external recording medium having higher power consumption. Further, JP-A-2004-349810 also discloses a technique to move a moving image recorded on the external recording medium having lower power consumption to the external recording medium having higher power consumption after a shooting operation is stopped.

Further, JP-A-2006-286034 discloses a technique to stop power supply to the second recording medium (DVD) during recording on the first recording medium (HDD) and stop power supply to the first recording medium during recording on the second recording medium, when the apparatus is operating on the battery.

### SUMMARY OF THE INVENTION

With a DVD/HDD hybrid camera, in comparison with a HDD drive, semiconductor memory, and other recording devices, the DVD drive which includes a laser drive module, a motor controller, etc. is likely to have a large circuit scale resulting in high power consumption. In particular, a BD (Blu-ray Disc) which is a mass-storage optical disc using blue-violet laser has still higher power consumption. Almost all part of power consumption is converted to heat, resulting in temperature rise not only in the DVD drive but also inside the camera. As a result, operating temperature of any one of electrical components (ICs, etc.) in the apparatus is exceeded which may cause failure or malfunction.

In order to reduce temperature rise, it is effective to diffuse heat inside the apparatus to the outside by use of a fin, a fan, or other radiating components, or increase the amount of heat radiation by increasing the surface area of the apparatus. With either method, however, there arises a problem of an increase in size of the camera apparatus because of the implementation of heat radiating components.

Although above-mentioned JP-A-2004-349810 and JP-A-2006-286034 aim at the reduction of the power consumption during battery operation, it cannot be said that heat generation of the apparatus is sufficiently taken into consideration. Although above-mentioned JP-A-2004-349810 and JP-A-2006-286034 have effects of preventing battery consumption by restraining integrated value of power consumption, it is possible to perform shooting-and-recording operation and editing-and-dubbing operation in parallel. Therefore, during the parallel operation, there is a risk that the power consumption rapidly increases resulting in excessive heat release value.

An object of the present invention is to provide a hybrid video camera that can be downsized while restraining heat generation during operation.

A hybrid video camera according to the present invention comprises: a camera module which shoots a subject and generates image data; a first recording module which records and reproduces the image data in relation to a first recording medium; a second recording module which records and reproduces the image data in relation to a second recording medium; and a controller which controls operations of the camera module and the first and second recording modules; wherein, if the power consumption of the second recording module is higher than that of the first recording module at the time of recording/reproduction, the controller instructs only the first recording module to record shot image data from the camera module in the shooting mode, and instructs the camera module to stop operation in the reproduction or editing mode of the recorded image data.

Further, the hybrid video camera according to the present invention comprises: a camera module which shoots a subject and generates image data; a hard disk drive which records and reproduces the image data in relation to the hard disk; an optical disc drive which records and reproduces the image data in relation to an optical disc; and a controller which controls operations of the camera module, the hard disk drive, and the optical disc drive; wherein, the controller instructs only the hard disk drive to record shot image data from the camera module in the shooting mode, and selects the sleep mode in which the camera module stands ready with the minimum power consumption in the reproduction or editing mode using an optical disc drive.

In accordance with the present invention, it is possible to provide a hybrid video camera that can be downsized and free from failure and malfunction due to heat generation.

### BRIEF DESCRIPTION OF THE DRAWINGS

These and other features, objects and advantages of the present invention will become more apparent from the following description when taken in conjunction with the accompanying drawings wherein:

FIG. 1 is a block diagram of an embodiment of a hybrid video camera according to the present invention.

FIG. 2 is a diagram showing each operation mode and an example of power consumption in each mode according to the present embodiment.

FIG. 3 is a flow chart showing operation control according to the present embodiment.

### DETAILED DESCRIPTION OF THE PREFERRED EMBODIMENTS

An embodiment of the present invention will be explained below with reference to the accompanying drawings.

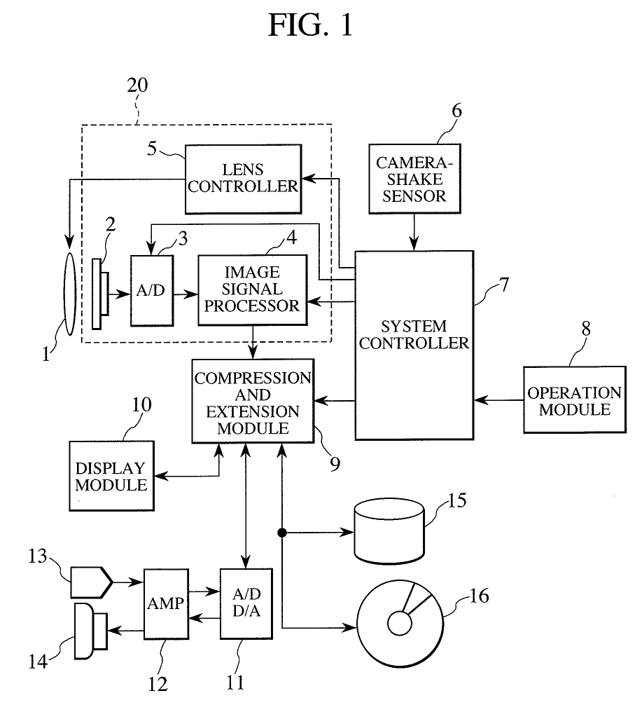

FIG. 1 is a block diagram of an embodiment of the hybrid video camera according to the present invention.

With an imaging system, a subject image is made on an imaging device 2 such as a CCD through a lens 1, an image signal is obtained from the imaging device 2 and then converted to a digital signal by an AD converter 3. At the time of shooting, a lens controller 5 adjusts the focus and light intensity of the subject, and a camera-shake sensor 6 detects the shaking of the camera body. An image signal processor (DSP) 4 performs processing for converting the image signal to image data for recording. The imaging device 2, the A/D converter 3, the image signal processor (DSP) 4, and the lens controller 5, constituting a camera block 20 which operates at the time of shooting and enables switchover to the sleep mode in which the minimum electric power is supplied when the camera is not operating. On the other hand, a sound signal obtained by a microphone 13 passes through an amplifier 12 and an A/D D/A converter 11 so as to be converted to digital sound data. A compression and extension module 9 compresses the image and sound data through a predetermined method, such as MPEG, to form a recording signal to be sent to a recording system.

The recording system is provided with two different recording modules (drives) mounting different recording media. The first recording module is, for example, a hard disk drive (HDD) 15 having low power consumption, and the second recording module is, for example, a DVD drive 16 having high power consumption. As mentioned later, the drive subjected to data recording is limited to the HDD 15 at the time of shooting. This also applies to a case when semiconductor memory is used as the first recording medium, and a Blu-ray optical disc (BD) or HDDVD (High-Definition DVD) is used as the second recording medium.

A reproducing system extends data reproduced from the HDD 15 or DVD drive 16 by means of the compression and extension module 9, and outputs image data to a display module 10, such as a liquid crystal display (LCD) or an electronic view finder (EVF). The reproducing system converts sound data to an analog signal by means of the A/D D/A converter 11, and outputs the analog signal to a speaker 14.

A system controller 7 controls each module in the camera in response to each operation mode of the camera. That is, the system controller 7 limits operations of the imaging and recording systems in response to a command from an operation module 8 and performs control so as to restrain the power consumption (heat generation) in the apparatus.

The operation module 8 is provided with the following switches to allow the user to perform operations.
Power switch: Turns ON/OFF the entire camera apparatus.
REC switch: When pressed when the camera module is in the shooting-ready state (ON state), recording of shot image data is started by a predetermined recording module. When pressed again (OFF state), recording is stopped.
HDD navigation switch: When pressed (ON state), the reproduction/editing screen of the HDD 15 appears. Specifically, shot scenes recorded in the HDD 15 are displayed as a thumbnail in the display module 10, and the camera enters a mode in which it is possible to delete and split a scene, dub a scene from the HDD 15 to the DVD drive 16, and perform other editing operations. When pressed again (OFF state), the shooting-ready state is resumed.
DVD navigation switch: When pressed (ON state), the reproduction/editing screen of the DVD 16 appears. Specifically, shot scenes recorded in the DVD drive 16 are displayed as a thumbnail in the display module 10, and the camera enters a mode in which it is possible to delete and split a scene, dub a scene from the DVD drive 16 to the HDD 15, and perform other editing operations. When pressed again (OFF state), the shooting-ready state is resumed.
Other switches: Includes a view angle adjustment switch (Tele/Wide), a speaker volume operation switch, a menu switch for showing/hiding a camera setup menu, cursor movement keys (arrow keys), etc.

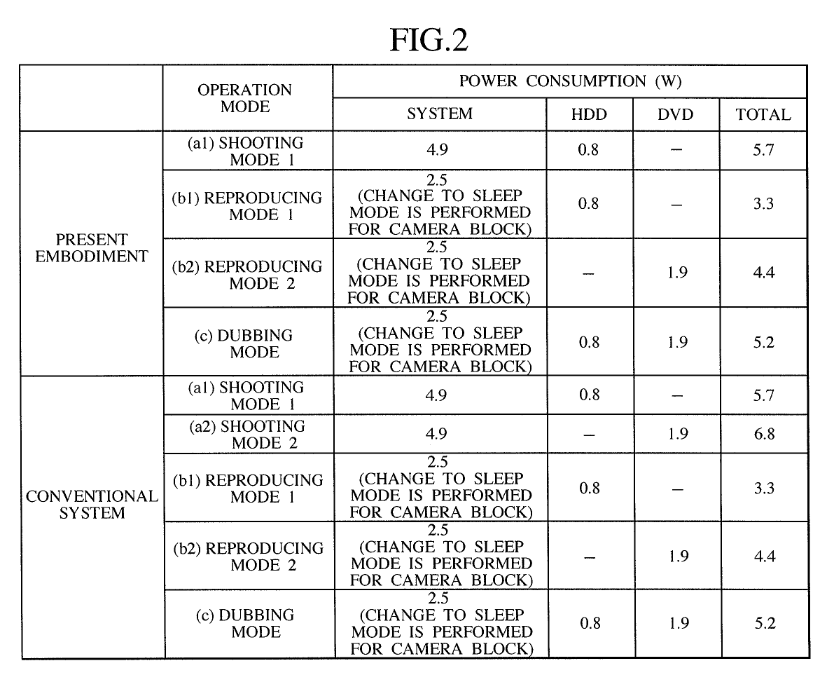

FIG. 2 is a diagram showing each operation mode and an example of power consumption in each mode according to the present embodiment. The power consumption of the entire system (including the camera block) excluding the recording system is 4.9 W. When shooting processing is stopped and the camera block is changed to the sleep mode in which the camera module stands ready with the minimum power consumption, the power consumption decreases to 2.5 W. With the recording system, the maximum power consumption is 0.8 W at the time of recording and reproduction using the HDD and 1.9 W at time of recording and reproduction using the DVD (BD) drive.

As the shooting mode, a conventional system is provided with both the HDD recording mode (a1) and the DVD recording mode (a2). The present embodiment, however, inhibits the DVD recording mode (a2) and permits only the HDD recording mode (a1). As a result, the total power consumption has been reduced from 6.8 W to 5.7 W.

In the case of the DVD/HDD hybrid camera, operation is guaranteed at ambient temperature of 0 to 40° C. Further, since operating ambient temperature of electrical components such as ICs is generally 85° C., it is necessary to restrain internal temperature rise of a product to 45° C. or below. There is a following relation between internal temperature rise and the product surface area.

Surface area=Power consumption/(Overall heat transfer coefficient×Internal temperature rise)

where the overall heat transfer coefficient is that of a molded material which forms the product outer wall, typically, 4 W/m²° C. Therefore, with a conventional camera apparatus, it is necessary to allocate a surface area of 0.038 m² (with power consumption of 6.8 W) from the above-mentioned formula. With the present embodiment, the surface area is 0.032 m² (with power consumption of 5.7 W), making it possible to contribute to the downsizing of the apparatus.

Further, the following can be said as a trend of the DVD/HDD hybrid camera.
Power consumption and heat release value of the camera module are increasing with increasing processing data because of the increased number of pixels of Hi-Vision, etc.
Power consumption and heat release value of the DVD module are also increasing with increasing record data and recording power because of the increased capacity of BD, etc.
With the HDD module, a large volume of data has been conventionally processed by a PC, etc. and there arises no problem with such an amount of data as shot image data.

Taking these points into consideration, it is most effective, as a measure of reducing the power consumption and heat release value, to inhibit simultaneous operations of the camera module and the DVD module.

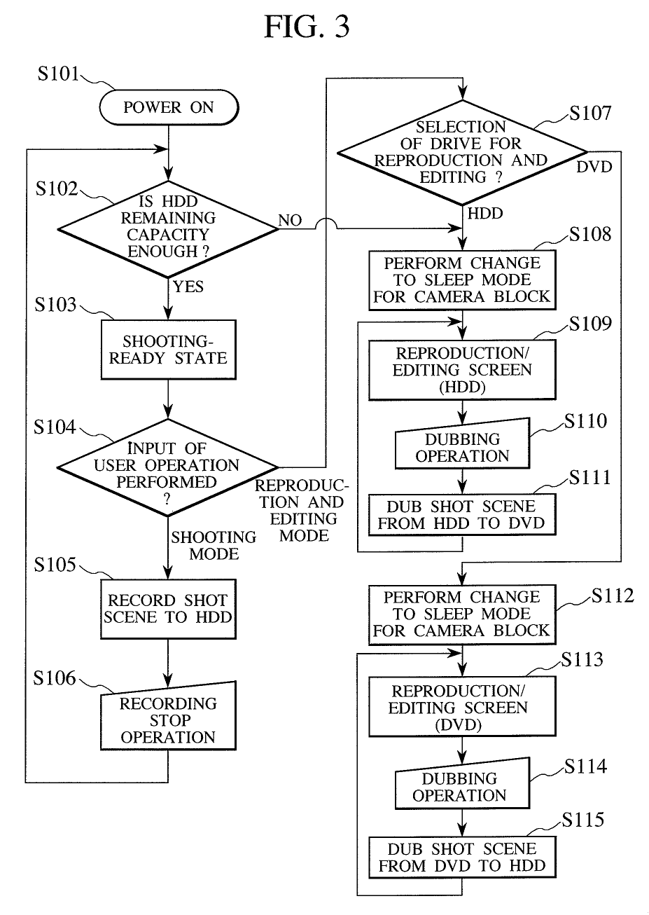

FIG. 3 is a flow chart showing operation control of the hybrid video camera according to the present embodiment.

When the power switch is turned ON in S101, the remaining capacity of the HDD is checked in S102 to determine whether or not a predetermined capacity is available. If the remaining capacity is enough, processing proceeds to the image pickup operation from S103 on; otherwise, processing proceeds to S108 to dub image data from the HDD to the DVD to allocate a new recordable area on the HDD.

In S103, electric power is supplied to the camera block 20 to change the camera block to the shooting-ready state. In this state, the imaging device 2, the A/D converter 3, the image signal processor (DSP) 4, and the lens controller 5 are activated, and an image signal from the image signal processor (DSP) 4 is outputted to the display module 10 on a through basis. Then, the apparatus waits for a user command to record data on the HDD 15.

In S104, the operation module 8 receives an input of a user operation. If the received user command is the shooting mode (REC switch turned ON), processing proceeds to S105; if it is the reproduction/editing mode (the HDD navigation switch or DVD navigation switch turned ON), processing proceeds to S107.

In S105, the compression and extension module 9 compresses an image pickup signal from the camera block 20 into image data, and records shot scenes on the HDD 15. In this case, recording on the DVD 16 is inhibited. If a user command to stop shooting (REC switch turned OFF) is received in S106, recording on the HDD 15 is stopped.

In S107, reproducing and editing operations of recorded data are performed, and a drive (HDD 15 or DVD 16) is selected. If the HDD is selected, processing proceeds to S108; otherwise, processing proceeds to S112.

In S108, the mode of the camera block 20 is changed over from the shooting-ready state to the sleep mode. The sleep mode is a mode in which signal processing operation of the camera block 20 is stopped, and the camera module stands ready with the minimum power consumption for maintaining the memory, etc.

In S109, shot scenes recorded on the HDD 15 are displayed in list form in the display module 10. The user can select a desired scene from the list to play it back, edit or split a specific shot scene, or perform other editing operations. Further, if the user instructs dubbing operation in S110, dubbing from the HDD 15 to the DVD 16 is performed in S111. Specifically, a scene specified from the HDD 15 by the user is read out and then copied to the DVD 16. Then, the scene read out from the HDD 15 is erased to create an empty area.

If dubbing operation to the DVD (S110) is not performed in reproducing and editing operations of the HDD 15 in S109, the DVD 16 does not operate. If the DVD 16 does not operate, the power consumption remains low and therefore it is not necessary to change the camera block 20 from the shooting-ready state to the sleep mode. In this case, it is preferable to execute S108 after S110.

In S112, on the other hand, the camera block 20 is changed over from the shooting-ready state to the sleep mode.

In S113, shot scenes recorded on the DVD 16 are displayed in list form in the display module 10. The user can select a desired scene from the list to play it back, edit or split a specific shot scene, or perform other editing operations. Further, if the user instructs dubbing operation in S114, dubbing from the DVD 16 to the HDD 15 is performed in S115. Specifically, a scene specified from DVD 16 by the user is read out and then copied to the HDD 15. Then, the scene read out from the DVD 16 is erased as required to create an empty area.

With the present embodiment, in above-mentioned S105, the drive subjected to data recording in the shooting mode is limited to the HDD 15 and recording on the DVD 16 is inhibited. Further, in above-mentioned S108 and S112, the camera block 20 is changed over to the sleep mode if it is in the reproduction/editing mode. The above-mentioned control prevents simultaneous operations of the camera block 20 and the DVD 16, making it possible to prevent excessive instantaneous power consumption, i.e., heat release value.

With the above-mentioned embodiment, a case where a HDD and a DVD are used as recording media having different power consumption has been explained, the present invention is also applicable to a combination of any other recording media. Further, when three or more different types of recording media are used, it is possible to obtain the same effect by limiting operations of the camera block and the drives as required depending on the power consumption.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

In the above embodiments each elements at least expressed as “module” can be realized by a hardware or a software or both to achieve the function and the operation explained in the part.

What is claimed is:

1. A hybrid video camera which shoots a subject and enables recording of shot image data on at least two different types of recording media, the hybrid video camera comprising:
a camera module which shoots a subject and generates image data;
a first recording module which records and reproduces the image data in relation to a first recording medium;
a second recording module which records and reproduces the image data in relation to a second recording medium; and
a control module which controls operations of the camera module and the first and second recording modules;
wherein, if the power consumption of the second recording module is higher than that of the first recording module at the time of recording/reproduction, the control module instructs only the first recording module to record shot image data from the camera module in the shooting mode, and instructs the camera module to stop operation in the reproduction or editing mode of recorded image data.

2. A hybrid video camera which shoots a subject and enables recording of shot image data on at least two different types of recording media, the hybrid video camera comprising:
a camera module which shoots a subject and generates image data;
a first recording module which records and reproduces the image data in relation to a first recording medium;
a second recording module which records and reproduces the image data in relation to a second recording medium; and
a control module which controls operations of the camera module and the first and second recording modules;
wherein, if the power consumption of the second recording module is higher than that of the first recording module at the time of recording/reproduction, the control module instructs the second recording module not to record shot image data from the camera module in the shooting mode, and instructs the camera module to stop operation in the reproduction or editing mode of recorded image data.

3. The hybrid video camera according to claim 1, wherein:
the control module selects the sleep mode in which the camera module stands ready with the minimum power consumption in the reproduction or editing mode.

4. The hybrid video camera according to claim 3, wherein:
the control module changes the camera module to the sleep mode when using the second recording module in the reproduction or editing mode.

5. The hybrid video camera according to claim 3, wherein:
the control module changes the camera module to the sleep mode when dubbing image data between the first and second recording modules.

6. The hybrid video camera according to claim 5, wherein:
if the remaining capacity of the first recording medium used for the first recording module is not enough, the control module changes the camera module to the sleep mode and dubs image data from the first recording module to the second recording module.

7. The hybrid video camera according to claim 1, wherein:
the first recording medium is a hard disk, and the second recording medium is an optical disc.

8. The hybrid video camera according to claim 7, wherein:
the second recording medium is a Blu-ray optical disc.

9. A hybrid video camera which shoots a subject and enables recording of shot image data on a hard disk and an optical disc, the hybrid video camera comprising:
a camera module which shoots a subject and generates image data;
a hard disk drive which records and reproduces the image data in relation to the hard disk;
an optical disc drive which records and reproduces the image data in relation to an optical disc; and
a control module which controls operations of the camera module, the hard disk drive, and the optical disc drive;
wherein the control module instructs only the hard disk drive to record shot image data from the camera module in the shooting mode, and selects the sleep mode in which the camera module stands ready with the minimum power consumption in the reproduction or editing mode using the optical disc drive.

10. A hybrid video camera which shoots a subject and enables recording of shot image data on a hard disk and an optical disc, the hybrid video camera comprising:
a camera module which shoots a subject and generates image data;
a hard disk drive which records and reproduces the image data in relation to the hard disk;
an optical disc drive which records and reproduces the image data in relation to an optical disc; and
a control module which controls operations of the camera module, the hard disk drive, and the optical disc drive;
wherein the control module instructs the optical disc drive not to record shot image data from the camera module in the shooting mode, and selects the sleep mode in which the camera module stands ready with the minimum power consumption in the reproduction or editing mode using the optical disc drive.
